(19) United States
(12) Patent Application Publication
(10) Pub. No.: US 2023/0067229 A1
(43) Pub. Date: Mar. 2, 2023

(54) METAL CHIP CARD ABLE TO FUNCTION CONTACTLESSLY

(71) Applicant: IDEMIA FRANCE, COURBEVOIE (FR)

(72) Inventors: Ahmed ALI, COURBEVOIE (FR); Tiphaine GROULT, COURBEVOIE (FR)

(21) Appl. No.: 17/789,838

(22) PCT Filed: Dec. 2, 2020
(86) PCT No.: PCT/FR2020/052254

§ 371 Date: Jun. 29, 2022

(30) Foreign Application Priority Data
Dec. 31, 2019 (FR) FR1915760

(51) Int. Cl. G06K 19/077

(52) U.S. Cl. CPC G06K 19/07728; G06K 19/07771

(57) ABSTRACT

A smart card including an upper metal layer and a lower metal layer disposed opposite each other; an internal cavity arranged between the upper and lower metal layers; and an RF antenna disposed in the internal cavity; in which the upper and lower metal layers each include a partially recessed area opposite the RF antenna, each partially recessed area including at least one opening through the thickness of the metal layer and each partially recessed area being partially covered by at least one metal protrusion extending from one edge of the partially recessed area so as to define the contour of the at least one opening.

### FIELD

The disclosure relates to the field of smart cards and relates more particularly to metal smart cards able to operate in contactless mode.

### BACKGROUND

The use of smart cards (or microcircuit cards) is now widespread in everyday life. Such cards are for example used as bank cards, loyalty cards, access cards, etc., and can take on various formats depending on their respective uses. Smart cards can be designed to perform various types of functions, in particular to conduct transactions, such as banking transactions (payment transaction, transfer transaction, etc.), authentication transactions, etc.

In known manner, a smart card generally includes a card body which is equipped with an electronic chip configured to process signals and to perform various functions depending on the desired use of the card. A smart card is also equipped with communication means allowing the electronic chip to interact with the outside, typically with an external terminal or drive.

Traditionally, a smart card is designed to cooperate with an external terminal by means of external contacts accessible to the surface of the card. An external terminal can thus position appropriate clip contacts on the external contacts of the card in order to establish contact communication.

More recently, contactless smart cards have experienced increasing growth due to the increased speed and simplicity related to contactless transactions. To do so, contactless cards embed a radiofrequency (RF) antenna allowing the transmission and receipt of RF signals with an external terminal. This RF antenna is generally composed of a plurality of conductive turns which extend into the body of the card.

The structure and appearance of smart cards may vary depending on the case. There is a trend today in offering users metal smart cards. It has been observed that metal cards are more robust against mechanical stresses and are therefore less susceptible to breakage or damage.

In addition, there is a growing demand for metal smart cards due in particular to the attractive aesthetic appearance of these cards (metallic reflections, brushed effect on the surface, etc.), to the impression of quality that they can provide in the hands of their user (significant weight of the metal, etc.), or even to the associated connotation of prestige for their users. Due in particular to the greater weight and to their particular aesthetic appearances, these cards serve as a social marker and a differentiating factor particularly for wealthy people.

However, it has been observed that the presence of metal in the body of a smart card poses difficulties when the card embeds an RF antenna to operate in contactless mode. The metal acts as an electromagnetic shield and blocks or interferes with the RF signals exchanged by the RF antenna with the outside. The metal present in the card body can thus disrupt the contactless communications of a smart card with an external terminal and prevent, for example, the conduction of a contactless transaction (payment or the like).

There is therefore a need for a solution that allows the production of a heavy and robust metal smart card for the reasons mentioned above, while guaranteeing that this card can communicate in contactless mode with the outside, in particular with an external terminal provided for that purpose. Particularly, it is desirable that a metal smart card (of the RFID type for example) be able to cooperate in contactless mode with an external terminal regardless of the orientation of the card vis-à-vis this terminal.

### SUMMARY

To this end, the present disclosure relates to a smart card including:
a plurality of metal layers including at least one upper metal layer and one lower metal layer disposed opposite each other;
an internal cavity arranged between the upper and lower metal layers; and
an RF antenna, including at least one conductive turn, disposed in the internal cavity;
in which the upper and lower metal layers each include a partially recessed area opposite the at least one turn, each partially recessed area including at least one opening through the thickness of the metal layer and each partially recessed area being partially covered by at least one metal protrusion extending from one edge (16) of the partially recessed area so as to define the contour of the at least one opening.

Thanks to the partially recessed areas positioned on either side of the RF antenna, it is advantageously possible to establish RF communication of the RF antenna through the partially recessed areas, without disturbing the magnetic flux of the RF antenna and this regardless of its orientation vis-à-vis an external terminal. The magnetic flux of the RF antenna is able to pass through the partially recessed areas through the through openings. In addition, the presence of one or several metal protrusions in each partially recessed area allows ensuring the physical integrity and the good robustness of the smart card without this being detrimental to the proper operation of the RF antenna. A user can thus use his smart card in contactless mode to interact with an external terminal, without concern for the orientation of the smart card.

According to one particular embodiment, the smart card includes at least one through slot extending in at least one metal layer from one edge of a partially recessed area to one peripheral edge of the metal layer.

According to one particular embodiment, the internal cavity is formed by at least one indentation in at least one among the upper and lower metal layers.

According to one particular embodiment, the smart card includes an intermediate metal layer positioned between the upper and lower metal layers, the internal cavity being formed by a through opening arranged in the intermediate metal layer.

According to one particular embodiment, each metal protrusion forms a finger (or metal finger) extending opposite (facing) at least one portion of the at least one turn. Thus, each partially recessed area includes at least one metal protrusion forming a finger opposite at least one portion of the at least one turn.

According to one particular embodiment, each partially recessed area includes a plurality of the metal protrusions forming fingers opposite at least one portion of the at least one turn.

According to one particular embodiment, each metal protrusion extends in one of the partially recessed areas so that its distal end is free, at a non-zero distance from the edge of the recessed area.

According to one particular embodiment, each partially recessed area includes a plurality of the metal protrusions separated from each other by at least one the opening so as to collectively form a metal interleaving partially covering the partially recessed area.

According to one particular embodiment, the metal protrusions of each partially recessed area form an interleaving whose pattern satisfies the Mushiake relationship.

According to one particular embodiment, each partially recessed area includes:
a plurality of metal protrusions forming concentric metal arcs in the partially recessed area; or
at least one metal protrusion extending spirally from one edge of the partially recessed area.

According to one particular embodiment, the partially recessed areas are positioned opposite each other.

According to one particular embodiment, the metal protrusions occupy at most 80% of the surface of each partially recessed area.

According to one particular embodiment, the through slots do not extend opposite each other.

According to one particular embodiment, the smart card is devoid of plastic material.

According to one particular embodiment, the upper metal layer, the lower metal layer and the RF antenna are electrically insulated from each other.

According to one particular embodiment, each partially recessed area is covered by an electrically insulating protective layer.

### BRIEF DESCRIPTION OF THE DRAWINGS

Other characteristics and advantages of the present disclosure will become apparent from the description given below, with reference to the appended drawings which illustrate exemplary embodiments without any limitation. In the figures:

FIG. 1 is a schematic sectional view of a smart card according to one particular embodiment of the disclosure;

FIG. 2 is a schematic top view of the front face of a smart card according one particular embodiment of the disclosure;

FIG. 3 is a schematic sectional view of a smart card according to one particular embodiment of the disclosure;

FIG. 4 is a schematic sectional view of a smart card according to one particular embodiment of the disclosure;

FIG. 5 is a schematic sectional view of a smart card according to one particular embodiment of the disclosure;

FIG. 6 is a schematic top view of a metal layer including a partially recessed area according to one particular embodiment of the disclosure;

FIG. 7 is a schematic top view of a metal layer including a partially recessed area according to one particular embodiment of the disclosure;

FIG. 8 is a schematic top view of a metal layer including a partially recessed area according to one particular embodiment of the disclosure; and

FIG. 9 is a schematic top view of a metal layer including a partially recessed area according to one particular embodiment of the disclosure.

### DETAILED DESCRIPTION

As indicated above, the disclosure relates to metal smart cards able to operate in contactless mode.

When a contactless smart card includes a metal plate as well as an RF antenna disposed on one of the faces of the metal plate, it has been observed that this metal plate disturbs the contactless communications between the RF antenna and the outside, particularly when the metal plate is disposed between the RF antenna and the external terminal with which the smart card tries to communicate, because of the electromagnetic shielding induced by the metal plate. Thus, depending on the orientation of the card, it is sometimes impossible to conduct a contactless transaction between a metal smart card and an external terminal. The transaction is possible if the smart card is presented so that the antenna is disposed on the side of the terminal (without the metal plate interposing between the two), but RF communications are disturbed, or even impossible, if the metal plate forms an electromagnetic barrier between the RF antenna of the card and the terminal (the metal plate acts as an electromagnetic barrier between the RF chip and the terminal).

The disclosure proposes to overcome the drawbacks and problems mentioned above. To do so, the disclosure proposes a metal card including an upper metal layer and a lower metal layer positioned on either side of a radiofrequency (RF) antenna. The upper and lower metal layers each include, opposite the RF antenna, a partially recessed area including at least one opening through the thickness of the metal layer. Each partially recessed area is partially covered by at least one metal protrusion extending from one edge of the partially recessed area so as to define the contour of the at least one opening.

The disclosure in particular provides for a smart card including: a plurality of the metal layers including at least one upper metal layer and one lower metal layer disposed opposite each other; an internal cavity arranged between the upper and lower metal layers; and an RF antenna, including at least one conductive turn, disposed in the cavity. The upper and lower metal layers each include a partially recessed area as defined above, opposite the at least one turn.

Particular embodiments, as well as other aspects of the disclosure, are described in more detail below.

In the present disclosure, examples of implementations of the disclosure are described in relation to a smart card configured to communicate only in contactless mode with the outside. To do so, this smart card in particular embeds an electronic chip connected to an RF antenna. The electronic chip is able to process signals and communicate with the outside via this RF antenna. However, other implementations are possible.

Alternatively, the disclosure also applies to “dual” type smart cards, that is to say cards with a double communication interface, having the capacity to communicate both in contact mode and in contactless mode. To do so, in addition to an RF antenna, the smart card is equipped with external contacts provided for this purpose on the surface of the card. The smart card can comply with the ISO 7816 standard.

The disclosure can be applied more generally to any smart card configured to communicate in contactless mode, whether or not it has the capacity to also operate in contact mode. The smart card of the disclosure can optionally be configured to operate according to the EMV standard, although other protocols and configurations are possible.

In general, the smart card of the disclosure can be configured to conduct a transaction of any type, such as banking transactions (payment, transfer, debit transactions, etc.), authentication transactions, etc. It can be a bank card, such as a payment card or credit card for example, or even an access badge, a loyalty card, an identity card, etc.

In the embodiments described below, the smart card includes a plurality of metal layers (at least 2). These metal layers (or plates) can have various thicknesses and can include various metals (or alloys of metals). Particularly, the metal layers of the smart card can include a single metal, such as aluminum for example, or an alloy of several different metals. These metal layers can include a plurality of metal sub-layers.

One aim of the disclosure is to allow the smart card to have a relatively significant weight compared to a traditional smart card whose card body is made of plastic. By adjusting the thickness and size of the metal plates, as well as the metals used, the weight of the smart card can be suitably adapted.

Unless otherwise indicated, the elements common or similar to several figures bear the same reference signs and have identical or similar characteristics, so that these common or similar elements are generally not described again for the sake of simplicity.

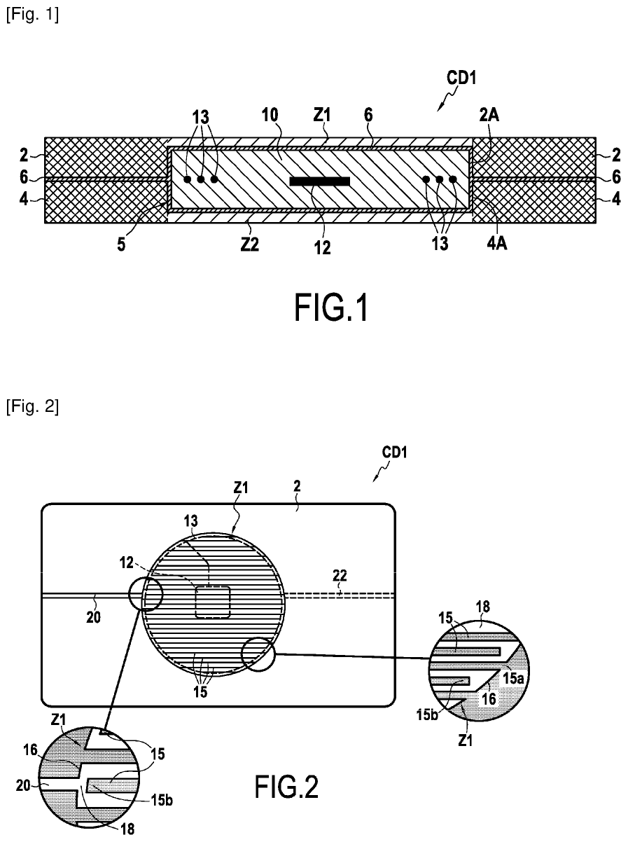

A smart card CD1 according to a first embodiment is now described with reference to FIGS. 1 and 2. According to this example, the smart card CD1 includes an upper metal layer 2 and a lower metal layer 4 disposed opposite each other. These two metal layers (or plates) 2, 4 are assembled together to form the body of the smart card CD1. This card body is for example of ID-1 format according to the ISO7816 standard, other formats being however possible.

An internal cavity (or internal housing) 5 is arranged between the upper and lower metal layers 2, 4. In this example, the metal layers 2 and 4 respectively include indentations (or recesses) 2a, 4a which collectively delimit the internal cavity 5. Alternatively, any one among the metal layers 2 and 4 has such an indentation.

The smart card CD1 also includes an RF antenna 13 disposed in the internal cavity 5. More particularly, a module (or insert) 10 including the RF antenna 13 is positioned in the internal cavity 5.

The RF antenna 13 includes one or a plurality of electrically conductive turns that allow establishing contactless communication (RF) with the outside, for example with an external terminal (not represented) provided for this purpose. The turns of the RF antenna 13 can be formed by a track, a wire or an electrically conductive member deposited on a support (not represented). Various (wired, deposition, etching) manufacturing techniques well known per se can be used to produce such an RF antenna. The physical characteristics (shape/size of the intersection, length of the antenna, number of turns, material, etc.) of the RF antenna 13 can be adapted on a case-by-case basis in order in particular to allow wireless communications at the desired frequency (or range of frequencies).

The smart card CD1 also includes an electronic chip (or microcircuit) 12 which is electrically connected to the RF antenna 13 in order to be able to communicate in contactless mode with the outside. In this exemplary embodiment, the electronic chip 12 is included in the antenna module 10, although other implementations are possible. The electronic chip 12 includes processing means for processing RF signals exchanged with an external terminal via the RF antenna 13.

Furthermore, the upper metal layer 2 and the lower metal layer 4 each include a partially recessed area—denoted respectively Z1 and Z2—positioned opposite (above and below, respectively) the electrically conductive turns of the RF antenna 13. In other words, the partially recessed areas Z1 and Z2 face the RF antenna 13. On the other hand, it is not necessary that these areas Z1, Z2 have a general shape identical or similar to that of the RF antenna 13. It is also not necessary that the partially recessed areas Z1 and Z2 be exactly aligned.

The partially recessed areas Z1, Z2 each include at least one through—opening 18, namely at least one opening (or recess, or perforation) through the thickness of the metal layer (2 or 4). Each of these partially recessed areas Z1, Z2 is partially covered by at least one metal protrusion 15 extending from one edge of the partially recessed area so as to define the contour of the through opening(s) 18. Thus, the turns of the RF antenna 13 are partially covered by the metal protrusions 15 of the partially recessed areas Z1, Z2, and are partially opposite at least one through opening 18 of each partially recessed area Z1, Z2.

Generally, a metal protrusion within the meaning of the disclosure can be any metal portion or member which extends in the form of a projection (or protuberance, or finger) from one edge of the partially recessed area. As indicated below, the shape and dimensions of each protrusion can be adapted by those skilled in the art on a case-by-case basis.

The positioning of such partially recessed areas Z1, Z2 opposite the RF antenna 13 advantageously allows establishing RF communication of the RF antenna 13 through the partially recessed areas Z1, Z2, without disturbing the magnetic flux of the RF antenna, regardless of its orientation. The magnetic flux of the RF antenna 13 is able to pass through the partially recessed areas Z1, Z2 through the through openings 18. In addition, the presence of one or multiple metal protrusions 15 in each partially recessed area allows ensuring the physical integrity and the good robustness of the smart card without this being detrimental to the proper operation of the RF antenna 13. A user can thus use his smart card in contactless mode to interact with an external terminal, without concern for the orientation of the smart card. Similar technical advantages are obtained in the other embodiments and variants described below.

As apparent throughout the disclosure, various configurations of metal protrusions and recesses are possible within the framework of the present disclosure. Particularly, the partially recessed areas within the meaning of the disclosure can have various patterns (or geometries) defined by the metal protrusion(s) 15. In the example represented in FIG. 2, it is assumed that the partially recessed areas Z1 and Z2 are identical although variants are possible in which the pattern of the partially recessed areas Z1 and Z2 differ. What is described below with reference to the partially recessed area Z1 therefore applies similarly to the partially recessed area Z2.

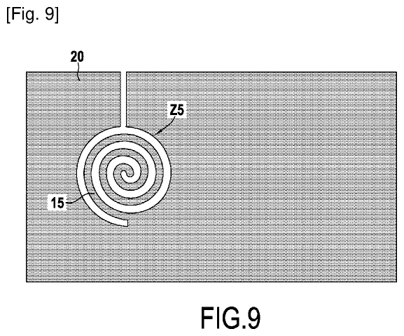

It is also assumed that the partially recessed areas Z1 and Z2 each include a plurality of metal protrusions 15, although variants are possible where a single metal protrusion 15 partially covers any one or both of the partially recessed areas Z1, Z2 to define at least one through opening 18, as described later (cf. for example FIG. 9).

The metal protrusions 15 form in the example of FIG. 2 and in the other examples below “fingers”, namely elongated portions, which extend opposite a portion of the RF antenna 13 (therefore opposite a portion of at least one turn). The shape and length of the metal protrusions 15 can be adapted by those skilled in the art as appropriate. In the example considered here, the metal protrusions 15 are rectilinear, variants being described below.

In the particular example represented in FIG. 2, the protrusions 15 extend in the partially recessed area Z1 from one edge 16 so as to delimit the contour of a single through opening 18 through the thickness of the upper metal layer 2. This single opening 18 here has a complex (zigzag) shape which meanders between the protrusions 15. The shape and the number of openings 18 can however vary according to the configuration of the protrusions 15 which is adopted. According to one variant, the partially recessed areas Z1, Z2 include a plurality of through openings 18 whose contour is defined by the metal protrusion(s) 15.

In the example represented in FIG. 2, the metal protrusions 15 of the partially recessed area Z1 are separated from each other by the single through opening 18 so as to collectively form a metal interleaving partially covering the partially recessed area Z1. According to one variant, the metal protrusions 15 of the partially recessed area Z1 are separated from each other by a plurality of through openings 18 so as to collectively form a metal interleaving partially covering the partially recessed area Z1. In general, the metal interleaving of the metal protrusions 15 forms a pattern whose nature can vary depending on the case.

In addition, as represented in FIG. 2, each metal protrusion 15 extends in this example from its proximal end 15a into one of the partially recessed areas Z1, Z2 so that its distal end 15b is free, that is to say at a non-zero distance from the edge 15 of the partially recessed area. In one particular example, each metal protrusion 15 ends at its distal part 15b at a (non-zero) distance vis-à-vis the other metal protrusions 15 and vis-à-vis the edge 16 of the recessed area Z1, Z2. The non-zero spacing between the distal part 15b of the metal protrusions 15 vis-à-vis the edge of the partially recessed area Z1, Z2 (and possibly also vis-à-vis the other metal protrusions 15) allows establishing open circuits between the metal protrusions 15 and the rest of the considered metal layer 2, 4. This configuration advantageously allows avoiding the creation of Eddy currents in the critical region of the partially recessed areas Z1, Z2. Avoiding creating Eddy currents thus advantageously avoids disturbing the contactless communications of the RF antenna 13 through the partially recessed areas Z1, Z2 with the outside.

In the example considered here, the protrusions 15 form an integral part of the upper or lower metal layers 2, 4 respectively. Alternatively, the protrusions 15 can be added elements which are fixed to the upper and lower metal layers 2, 4 at the edge 16 of the respective partially recessed areas Z1, Z2.

The metal protrusions 15 can be formed in various ways, for example by stamping directly into the material of the metal layers 2, 4. According to one particular embodiment, the protrusions 15 in the partially recessed areas Z1 and Z2 are formed by laser etching or mechanical etching. The metal of the metal layers 2 and 4 is thus etched so as to make the through opening(s) 18 delimiting the contour of the metal protrusions 15.

In the example represented in FIGS. 1 and 2, the partially recessed areas Z1 and Z2 are positioned opposite each other, the RF antenna 13 being interposed between these two areas, so as to allow good communication of the RF antenna with the outside and so that the behavior of the RF antenna is uniform regardless of the orientation of the smart card CD1 vis-à-vis an external terminal with which it interacts. Variants of implementations are however possible in which the partially recessed areas Z1 and Z2 are not aligned (partially facing each other).

In the example represented in FIGS. 1 and 2, the partially recessed areas Z1, Z2 have a generally circular shape. However, other shapes are possible.

Furthermore, as represented in FIG. 1, the RF antenna 13 (and more specifically the antenna module 10 in this example) is electrically insulated from the upper and lower metal layers 2, 4 (including the partially recessed areas Z1, Z2) by means of an electrically insulating glue (or adhesive) 6 which fixes all these elements together. This electrical insulation 6 allows preventing the metal neighboring the RF antenna 13 from disturbing the latter in its operation. Other ways of electrically insulating the RF antenna 13 can however be envisaged. Alternatively, any electrically insulating material 6 (plastic material, dielectric material) can be disposed around the RF antenna 13 (that is to say around the antenna module 10) to electrically insulate it from the metal layers of the smart card. Layers 6 of electrically insulating material can thus be disposed at the interface between the antenna module 10 and the two metal layers 2 and 4 (including between the antenna module 10 and the partially recessed areas Z1 and Z2).

An electrically insulating material (not represented) can also be disposed so as to cover the upper and lower metal layers 2, 4, or at least the partially recessed areas Z1, Z2. According to one particular example, each partially recessed area Z1, Z2 is covered by an electrically insulating protective layer. By thus insulating the external faces of the smart card CD1, the risks of short circuits are limited, in particular due to the presence of Eddy currents in the partially recessed areas Z1, Z2 (for example due to the presence of a drop of water between the metal protrusions 15).

On the other hand, as represented in FIG. 2, the upper and lower metal layers 2, 4 each include a through slot denoted 20, 22 respectively. These through slots 20, 22 extend respectively from the partially recessed area Z1 and Z2 up to a peripheral edge of the upper and lower metal layers 2, 4, so as to avoid the formation of Eddy currents. To do so, each through slot 20, 22 opens out onto a through opening 18 (namely the single opening 18 in the present case) of the corresponding partially recessed area Z1, Z2. Each through slot 20, 22 thus extends an opening 18 up to a peripheral edge of the metal layer 2 or 4. According to one particular example, the through slots 20, 22 open out respectively onto the partially recessed areas Z1, Z2 so as to be positioned opposite the distal end 15b of a metal protrusion 15. The shape and configuration of the through slots 20, 22 can vary depending on the case. The formation of such through slots advantageously allows reducing or preventing the formation of Eddy currents that may disturb the proper operation of the RF antenna 13. Indeed, these slots limit the main Eddy current loops that may generated around the RF antenna 13.

The through slots 20, 22 are for example disposed so as to be opposite to each other relative to the RF antenna 13. The through slots 20, 22 extend for example so as to open out onto opposite sides (or edges) of the body of the smart card CD1. The through slots 20, 22 can be rectilinear or have more complex shapes. The electrical insulation 6 allows preventing the opposite edges of the through slot 20 (and respectively of the through slot 22) from being directly short-circuited due to the metal layer 4 (and respectively the metal layer 2) located nearby.

In general, the through slots 20 and 22 may not extend facing each other, as for example in the case of FIG. 2. In other words, these slots may be misaligned relative to each other in order to preserve the physical integrity and the robustness of the smart card CD1.

It should be noted that in the example represented in FIG. 2, the through slots 20, 22 are arranged in the upper and lower metal layers forming the body of the smart card CD1. As described below, variants are possible according to which one or more through slot(s) similar to the slots 20, 22 are arranged in one or more metal layer(s) other than those including the partially recessed areas Z1, Z2. As indicated below, other implementations are possible in which the smart card includes one or more additional metal layer(s) which, although not including a partially recessed area, also include at least one through slot. According to one particular example, each metal layer extending up to the peripheral edge of the smart card includes at least one such through slot to limit Eddy currents.

According to one variant, only any one of the upper and lower metal layers 2 and 4 includes such a through slot. Embodiments are also possible in which no through slot 20, 22 is made in the smart card CD1.

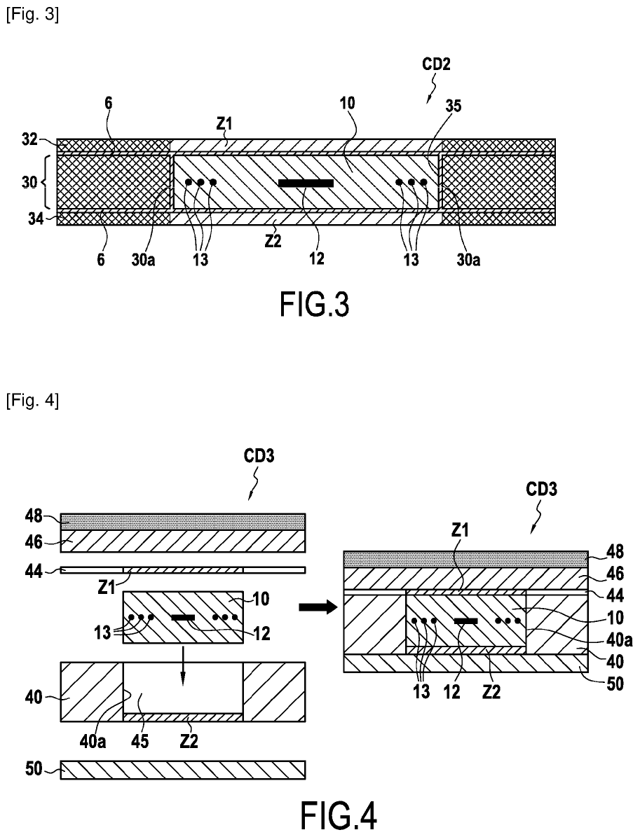

Alternative embodiments are now described with reference to FIGS. 3-9. The different characteristics and variants (concerning in particular the partially recessed areas, the RF antenna, the electrical insulation and any through slots) described above with reference to FIGS. 1 and 2, as well as the associated manufacturing techniques (particularly for the RF antenna and the partially recessed areas), can be applied analogously to the variants below.

FIG. 3 schematically represents a sectional view of a smart card CD2 according to one particular embodiment of the disclosure.

The smart card CD2 includes an upper metal layer 32 and a lower metal layer 34. An intermediate metal layer 30 is interposed between the upper and lower metal layers 32, 34. This intermediate metal layer 30 includes a through opening 30a which delimits an internal cavity 35 of the smart card CD2.

An RF antenna 13 as previously described with reference to FIGS. 1 and 2 is furthermore disposed in the cavity 35 arranged in the intermediate metal layer 30. In this example, a module (or insert) 10 including the RF antenna 13 is thus positioned in the internal cavity 35. The RF antenna 13 is electrically connected to an electronic chip 12 present in the body of the smart card CD2 (in this example the electronic chip 12 is included in the antenna module 10). As already described, the RF antenna 13 includes at least one electrically conductive turn to allow the electronic chip to communicate in contactless mode with the outside of the card.

The upper and lower metal layers 32, 34 respectively include partially recessed areas Z1, Z2 opposite the turns of the RF antenna 13. The partially recessed areas Z1 and Z2 are generally as already described with reference to the embodiment of FIGS. 1 and 2. Particularly, each partially recessed area Z1, Z2 includes at least one through opening through the thickness of the corresponding metal layer 32, 34. In addition, each partially recessed area Z1, Z2 is partially covered by at least one metal protrusion 15 extending from one edge 16 of the partially recessed area Z1, Z2 so as to define the contour of the at least one through opening 18. The partially recessed areas Z1, Z2 can have an identical or different pattern, for example such as the pattern represented in FIG. 2 or in FIGS. 6 to 8 described below.

The embodiment of FIG. 3 therefore differs mainly from FIGS. 1 and 2 in that an intermediate metal layer 30 disposed between the upper and lower metal layers forms the internal cavity accommodating the RF antenna 13. The configurations and variants described above with reference to FIGS. 1 and 2 (concerning in particular the configuration of the partially recessed areas and of the RF antenna) apply by analogy to the embodiment of FIG. 3.

In the example represented in FIG. 3, the electrical insulation between the RF antenna 13 and the neighboring metal is ensured by an insulating material 6 as already described above with reference to FIGS. 1 and 2 (for example an insulating glue or a dielectric material) which is interposed between the intermediate metal layer 30 and the upper metal layer 32 on the one hand, and between the intermediate metal layer 30 and the lower metal layer 34 on the other hand.

By thus equipping the smart card D2 with partially recessed areas Z1, Z2, the electronic chip is able to communicate effectively with the outside in contactless mode without the RF antenna 13 being disturbed by the metal layers of the smart card CD2. The magnetic fluxes can be exchanged between the RF antenna 13 and the outside via the partially recessed areas Z1, Z2, while ensuring the physical integrity and the robustness of the smart card CD2.

It is possible to adapt the thickness of the metal layers in order to obtain a smart card CD2 of appropriate weight.

It should be noted that through slots (not represented) can also be arranged in the upper and lower metal layers 32, 34 and in the intermediate metal layer 30 in a similar manner to the through slots 20, 22 previously described with reference to FIGS. 1 and 2. Thus, the metal layers 30, 32 and 34 can each include a through slot extending from respectively the partially recessed area Z1 and Z2 up to a peripheral edge of the metal layers so as to avoid the formation of Eddy currents that may disrupt the proper operation of the RF antenna 13, as already described. In the upper and lower metal layers 32 and 34, the through slots each open out onto a through opening 18 of the corresponding partially recessed area Z1, Z2. In the intermediate metal layer 30, the through slot opens out into the through opening 30a (therefore onto the cavity 35).

FIG. 4 schematically represents a sectional view of a smart card CD3 according to one particular embodiment of the disclosure.

The smart card CD3 includes an upper metal layer 44 and a lower metal layer 40 positioned opposite each other. The upper and lower metal layers 44, 40 include respectively a partially recessed area Z1, Z2 positioned opposite the turns of the RF antenna 13. The partially recessed areas Z1 and Z2 are generally as already described with reference to the embodiment of FIGS. 1 and 2.

Particularly, each partially recessed area Z1, Z2 includes at least one through opening 18 through the thickness of the corresponding metal layer 32, 34. Furthermore, each partially recessed area Z1, Z2 is partially covered by at least one metal protrusion 15 extending from one edge 16 of the partially recessed area Z1, Z2 so as to define the contour of the at least one through opening 18. The partially recessed areas Z1, Z2 can have an identical or different pattern, for example such as the pattern represented in FIG. 2 or in FIGS. 6 to 8 described below.

In this example, the partially recessed area Z2 forms an integral part of the lower metal layer 40. Alternatively, the partially recessed area Z2 is a metal layer distinct from the lower metal layer 40, these two metal layers being fixed to each other by any appropriate means so as to form together the same metal layer (or plate).

As represented in FIG. 4, the lower metal layer 40a here includes an indentation 40a which defines an internal cavity 45 in which an RF antenna 13 is disposed as already described above with reference to FIGS. 1 and 2.

As in the previous examples, a module (or insert) 10 including the RF antenna 13 is thus positioned in the internal cavity 45. The RF antenna 13 is electrically connected to an electronic chip 12 present in the body of the smart card CD3 (in this example the electronic chip 12 is included in the antenna module 10). As already described, the RF antenna 13 includes at least one electrically conductive turn to allow the electronic chip to communicate in contactless mode with the outside of the card.

The configurations and variants described above with reference to FIGS. 1 and 2 (concerning in particular the configuration of the partially recessed areas and of the RF antenna) apply similarly to the embodiment of FIG. 4.

A printed layer 46 can optionally be disposed on the upper face of the upper metal layer 44 in order to customize the visual appearance of the smart card CD3. In this example, electrically insulating protective layers 48 and 50 are also positioned so as to cover the external faces of the printed layer 46 (and, failing that, of the upper metal layer 44) and of the lower metal layer 40, respectively.

It should be noted that through slots (not represented) can also be arranged in the upper and lower metal layers 44, 40 in a manner similar to the through slots 20, 22 previously described with reference to FIGS. 1 and 2. Thus, the upper and lower metal layers 44, 40 can each include a through slot extending from respectively the partially recessed area Z1 and Z2, up to a peripheral edge of the upper and lower metal layers 44, 40 so as to avoid the formation of Eddy currents that may disturb the proper operation of the RF antenna 13, as already described. In the upper and lower metal layers 44, 40, the through slots each open out onto a through opening 18 of the corresponding partially recessed area Z1, Z2, respectively.

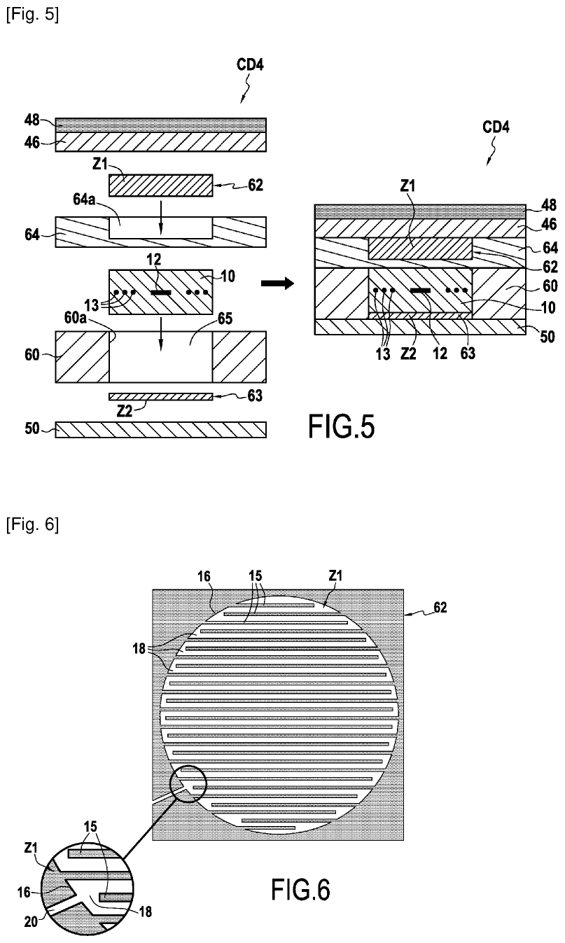

FIGS. 5 and 6 schematically represent a sectional view of a smart card CD4 according to one particular embodiment of the disclosure.

The smart card CD4 includes an upper metal layer 62 and a lower metal layer 63 positioned opposite each other. The upper and lower metal layers 62, 63 respectively include a partially recessed area Z1, Z2 positioned opposite the turns of the RF antenna 13.

The partially recessed areas Z1 and Z2 are generally as already described with reference to the embodiment of FIGS. 1 and 2.

Particularly, each partially recessed area Z1, Z2 includes at least one through opening 18 through the thickness of the corresponding metal layer 32, 34. Furthermore, each partially recessed area Z1, Z2 is partially covered by at least one metal protrusion 15 extending from one edge 16 of the partially recessed area Z1, Z2 so as to define the contour of the at least one through opening 18. The partially recessed areas Z1, Z2 may have an identical or different pattern, for example such as the pattern represented in FIG. 2 or in FIGS. 6 to 8 described below.

FIG. 6 represents the upper metal layer 62 including the partially recessed area Z1, according to one particular example. The lower metal layer 63 can have a structure (and in particular a pattern) similar to that of the upper metal layer 62.

The smart card CD4 further includes an intermediate metal layer 60 including a through opening 60a which forms an internal cavity 65 between the partially recessed areas Z1 and Z2. Within this cavity 65, an RF antenna 13 is disposed, as already described above with reference in particular to FIGS. 1 and 2. As in the previous examples, a module (or insert) 10 including the RF antenna 13 is thus positioned in the internal cavity 65. The RF antenna 13 is electrically connected to an electronic chip 12 present in the body of the smart card CD4 (in this example the electronic chip 12 is included in the antenna module 10). As already described, the RF antenna 13 includes at least one electrically conductive turn to allow the electronic chip to communicate in contactless mode with the outside of the card.

The configurations and variants described above with reference to FIGS. 1 and 2 (concerning in particular the configuration of the partially recessed areas and of the RF antenna) apply by analogy to the embodiment of FIG. 4.

In this example, the upper metal layer 62 including the partially recessed area Z1 does not extend throughout the body of the smart card CD4 and is not directly in contact with the intermediate metal layer 60. The metal layer 62 however, has a sufficient size for its partially recessed area Z1 to cover the RF antenna 13 (or at least a substantial portion of the turns of the antenna). An intermediate dielectric layer 64 is interposed between the upper metal layer 62 and the intermediate metal layer 60. This intermediate dielectric layer 64 extends throughout the card body and forms an indentation 64a in which the upper metal layer 62 including the partially recessed area Z1 is disposed.

Furthermore, the lower metal layer 63 is fixed to the intermediate metal layer 60 so as to cover the internal cavity 65 from the lower face of the intermediate metal layer 60. Alternatively, the lower metal layer 63 forms an integral part of the intermediate metal layer 60.

It should be noted that through slots (not represented) can also be arranged in the intermediate metal layer 60 and in the metal layer 62 in a manner similar to the through slots 20, 22 previously described with reference to FIGS. 1 and 2. In this example, a through slot extends into the intermediate metal layer 60 and extends into the metal layer 62, from a peripheral edge of the intermediate metal layer 60 up to the partially recessed area Z2, so as to avoid the formation of Eddy currents that may disturb the proper operation of the RF antenna 13, as already described. Similarly, a through slot extends in the metal layer 62 from a peripheral edge of the metal layer up to the partially recessed area Z1. These two through slots thus open out onto a through opening 18 of the partially recessed areas Z1, Z2 respectively.

It should also be noted that, in the different embodiments described above, the RF antenna 13 is electrically insulated from the metal layers of the smart card, in a similar manner to what is described with reference to FIG. 1 or 3 for example.

As it appears from the previous exemplary embodiments, numerous configurations implementing partially recessed areas on either side of an RF antenna are possible to produce a metal smart card able to operate in contactless mode.

According to one particular example, the metal protrusions 15 have complementary shapes with respect to each other so as to form a pattern called “complementary” or “self-complementary” pattern. This pattern can present a symmetry in translation or in rotation, so that it is identical when a translation or a rotation respectively is conducted. This motif satisfies, for example, the Mushiake relationship well known to those skilled in the art (cf. for example Wikipedia: https://en.wikipedia.org/wiki/Self-complementary_antenna; also the publication: “Y. Mushiake, ‘Self-Complementary Antennas: Principle of Self-Complementarity for Constant Impedance,” 139 pages, Springer-Verlag London Ltd., London, 1996, in particular pages 75-80, ISBN: 978-3-540-76002-3.). Thus, the metal protrusions 15 of each partially recessed area Z1 and Z2 can form an interleaving whose pattern satisfies the Mushiake relationship, other patterns being however possible. It has been observed that such patterns, for example those satisfying the Mushiake relationship, allow effectively limiting the Eddy currents that may disturb the operation of the RF antenna.

As indicated above, the partially recessed areas arranged in the metal layers positioned on either side of the RF antenna advantageously allow the transmission of the magnetic fluxes between the RF antenna and the outside (for example with an external terminal having an adequate RF antenna). The metal protrusion(s) 15 extend into these partially recessed areas so as to partially cover them. The coverage rate (or filling rate) TR of each partially recessed area defines the proportion of surface covered by the metal protrusion(s) 15 relative to the total surface of the considered partially recessed area. According to one particular example, each partially recessed area is configured so that its coverage rate is such that TR≤80%, or even TR≤70%. In other words, the metal protrusion(s) 15 of each recessed area Z1, Z2 occupy a cumulative surface less than or equal to 80%, even 70%, of the total surface of each recessed area (TR≤80%), which allows guaranteeing proper operation of the RF antenna through the partially recessed areas (with a non-zero coverage rate TR (TR>0) to guarantee a minimum of robustness to the smart card). According to one particular example, the coverage rate of each partially recessed area is such that TR is equal or substantially equal to 50%, in order to ensure a good compromise between robustness of the smart card and proper operation of the RF antenna through partially recessed areas.

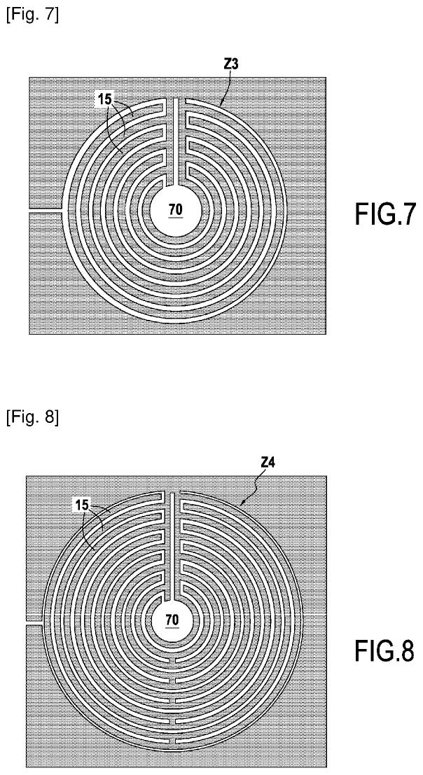

FIGS. 7, 8 and 9 represent examples of patterns that can form partially recessed areas within the meaning of the disclosure.

According to one particular example, each partially recessed area (or at least any one of them) includes a plurality of metal protrusions 15 forming concentric metal arcs in the partially recessed area. Partially recessed areas Z3 and Z4 having such a pattern are represented by way of example in FIGS. 7 and 8, respectively.

The concentric metal arcs can form a circular-shaped central opening 70 in the partially recessed area.

According to one particular example, each partially recessed area (or at least any one of them) includes a single metal protrusion forming a finger opposite at least one portion of the at least one antenna turn.

According to another particular example, each partially recessed area (or at least any one of them) includes one or several metal protrusions 15 which extend spirally from one edge of the area of the considered recessed area. A partially recessed area Z5 including a single spiral-shaped metal protrusion 15 is represented by way of example in FIG. 9. In this particular example, the metal protrusion 15 extends inwardly of the partially recessed area Z5 so as to maintain a non-zero constant deviation in any section with the adjacent sections of the metal protrusion.

The particular configurations in concentric and spiral arcs advantageously allow the magnetic flux to pass between the RF antenna and the outside while avoiding the undesirable formation of Eddy currents which could disturb the proper operation of the antenna.

As already indicated, one aim of the disclosure is to allow a metal smart card able to operate in contactless mode to present a general appearance and an attractive weight, to ensure good robustness of the whole while guaranteeing a proper operation of the RF antenna regardless of its orientation. It has in particular been observed that the presence of plastic material in a metal smart card can be a source of fragility for the card. Indeed, during its use, a smart card can be exposed to very extreme climatic conditions (temperature, humidity, etc.). Metal layers and plastic layers within the same smart card will respond differently to such environmental stresses, which will have the effect of weakening the smart card (risks of delamination, etc.). Also, according to one particular example, the smart card of the disclosure is devoid of plastic material or, at the very least, is devoid of a layer made of plastic material, so as to optimize the weight of the card and to ensure good robustness against climatic conditions.

Those skilled in the art will understand that the embodiments and variants described above only constitute non-limiting examples of implementation of the disclosure. Particularly, those skilled in the art may envisage any adaptation or combination of the embodiments and variants described above in order to meet a very specific need.

1. A smart card comprising:
a plurality of metal layers including at least one upper metal layer and one lower metal layer disposed opposite each other;
an internal cavity arranged between the upper and lower metal layers; and
an RF antenna comprising at least one conductive turn, disposed in the internal cavity;
wherein the upper and lower metal layers each comprise a partially recessed area opposite the at least one turn, each partially recessed area includes at least one opening through the thickness of the metal layer and each partially recessed area is partially covered by at least one metal protrusion extending from one edge of the partially recessed area so as to define the contour of the at least one opening.

2. The smart card according to claim 1, comprising at least one through slot extending in at least one metal layer from one edge of a partially recessed area to one peripheral edge of the metal layer.

3. The smart card according to claim 1, wherein the internal cavity is formed by at least one indentation in at least one among the upper and lower metal layers.

4. The smart card according to claim 1, comprising an intermediate metal layer positioned between the upper and lower metal layers, the internal cavity being formed by a through opening arranged in the intermediate metal layer.

5. The smart card according to claim 1 4, wherein each partially recessed area comprises a plurality of the metal protrusions forming fingers opposite at least one portion of the at least one turn.

6. The smart card according to claim 1, wherein each metal protrusion extends in one of the partially recessed areas so that its distal end is free, at a non-zero distance from the edge of the recessed area.

7. The smart card according to claim 1, wherein each partially recessed area comprises a plurality of the metal protrusions separated from each other by at least one the opening so as to collectively form a metal interleaving partially covering the partially recessed area.

8. The smart card according to claim 7, wherein the metal protrusions of each partially recessed area form an interleaving whose pattern satisfies a Mushiake relationship.

9. The smart card according to claim 1, wherein each partially recessed area includes:
a plurality of metal protrusions forming concentric metal arcs in the partially recessed area; or
at least one metal protrusion extending spirally from one edge of the partially recessed area.

10. The smart card according to claim 1, wherein the partially recessed areas are positioned opposite each other.

11. The smart card according to claim 1, wherein the metal protrusions occupy at most 80% of the surface of each partially recessed area.

12. The smart card according to claim 1, wherein the through slots do not extend opposite each other.

13. The smart card according to claim 1, wherein the smart card is devoid of plastic material.

14. The smart card according to claim 1, wherein the upper metal layer, the lower metal layer and the RF antenna are electrically insulated from each other.

15. The smart card according to claim 1, wherein each partially recessed area is covered by an electrically insulating protective layer.
